(19) United States
(12) Patent Application Publication
(10) Pub. No.: US 2026/0253330 A1
(43) Pub. Date: Aug. 27, 2026

(54) SYSTEM AND METHODS FOR 3D SCENE REPRESENTATION BASED ON COMPRESSED GAUSSIAN SPLATTING

(71) Applicants: CITY UNIVERSITY OF HONG KONG, Kowloon (HK); LINGNAN UNIVERSITY, Tuen Mun (HK)

(72) Inventors: Shiqi WANG, Kowloon (HK); Xiangrui LIU, Kowloon (HK); Xinju WU, Kowloon (HK); Sam Tak Wu KWONG, Tuen Mun (HK)

(21) Appl. No.: 19/063,077

(22) Filed: Feb. 25, 2025

(51) Int. Cl. G06T 17/10; G06T 15/08

(52) U.S. Cl. CPC G06T 17/10; G06T 15/08

(57) ABSTRACT

A computer-implemented method for representing 3D scenes. The method includes the steps of creating a plurality of first primitives, predicting a plurality of second primitives from the plurality of first primitives, and rendering 3D scenes based on the first and second primitives. The plurality of second primitives comprising residual embeddings. Incorporated with the hybrid primitive structure and rate-constrained optimization, this invention outperforms existing compression methods, achieving superior size reduction without compromising rendering quality.

### FIELD OF INVENTION

This invention relates to computer-generated 3D (three-dimensional) scenes.

### BACKGROUND OF INVENTION

Gaussian splatting (3DGS) [17] has been proposed as an efficient technique for 3D scene representation. In contrast to the preceding implicit neural radiance fields [3, 28, 32], 3DGS [17] intricately depicts scenes by explicit primitives termed 3D Gaussians, and achieves fast rendering through a parallel splatting pipeline [44], thereby significantly prompting 3D reconstruction [7, 13, 26] and view synthesis [21, 39, 40]. Nevertheless, 3DGS [17] requires a considerable quantity of 3D Gaussians to ensure high-quality rendering, typically escalating to millions in realistic scenarios. Consequently, the substantial burden on storage and bandwidth hinders the practical applications of 3DGS [17], and necessitates the development of compression methodologies.

Recent works [9, 10, 20, 33, 34] have demonstrated preliminary progress in compressing 3DGS [17] by diminishing both quantity and volume of 3D Gaussians. Generally, these methods incorporate heuristic pruning strategies to remove 3D Gaussians with insignificant contributions to rendering quality. Additionally, vector quantization is commonly applied to the retained 3D Gaussians for further size reduction, discretizing continuous attributes of 3D Gaussians into a finite set of codewords. However, extant methods fail to exploit the intrinsic characteristics within 3D Gaussians, leading to inferior compression efficacy. Specifically, these methods independently compress each 3D Gaussian and neglect the striking local similarities of 3D Gaussians evident, thereby inevitably leaving significant redundancies among these 3D Gaussians. Moreover, the optimization process in these methods solely centers on rendering distortion, which overlooks redundancies within attributes of each 3D Gaussian. Such drawbacks inherently hamper the compactness of 3D scene representations.

### REFERENCES

The following references are referred to throughout this specification, as indicated by the numbered brackets. The disclosures of each of these references are hereby incorporated by reference herein in their entireties for all purposes.
[1] Johannes Ballé, Valero Laparra, and Eero P Simoncelli. 2017. End-to-end Optimized Image Compression. In Proceedings of the International Conference on Learning Representations. 1-12.
[2] Johannes Ballé, David Minnen, Saurabh Singh, Sung Jin Hwang, and Nick Johnston. 2018. Variational Image Compression with A Scale Hyperprior. In Proceedings of the International Conference on Learning Representations. 1-13.
[3] Jonathan T Barron, Ben Mildenhall, Matthew Tancik, Peter Hedman, Ricardo Martin-Brualla, and Pratul P Srinivasan. 2021. Mip-NeRF: A Multiscale Representation for Anti-aliasing Neural Radiance Fields. In Proceedings of the IEEE/CVF International Conference on Computer Vision. 5855-5864.
[4] Jonathan T Barron, Ben Mildenhall, Dor Verbin, Pratul P Srinivasan, and Peter Hedman. 2022. Mip-NeRF 360: Unbounded Anti-aliased Neural Radiance Fields. In Proceedings of the IEEE/CVF Conference on Computer Vision and Pattern Recognition. 5470-5479.
[5] Jean Bégaint, Fabien Racapé, Simon Feltman, and Akshay Pushparaja. 2020. CompressAL: a PyTorch Library and Evaluation Platform for End-to-end Compression Research. arXiv preprint arXiv:2011.03029 (2020), 1-9.
[6] Benjamin Bross, Ye-Kui Wang, Yan Ye, Shan Liu, Jianle Chen, Gary J Sullivan, and Jens-Rainer Ohm. 2021. Overview of the Versatile Video Coding (VVC) Standard and its Applications. IEEE Transactions on Circuits and Systems for Video Technology 31, 10 (2021), 3736-3764.
[7] Duo Chen, Zixin Tang, and Yiguang Liu. 2022. Cyclical Fusion: Accurate 3D Reconstruction via Cyclical Monotonicity. In Proceedings of the ACM International Conference on Multimedia. 3955-3964.
[8] Kai Cheng, Xiaoxiao Long, Kaizhi Yang, Yao Yao, Wei Yin, Yuexin Ma, Wenping Wang, and Xuejin Chen. 2024. GaussianPro: 3D Gaussian Splatting with Progressive Propagation. arXiv preprint arXiv:2402.14650 (2024), 1-11.
[9] Zhiwen Fan, Kevin Wang, Kairun Wen, Zehao Zhu, Dejia Xu, and Zhangyang Wang. 2023. LightGaussian: Unbounded 3D Gaussian Compression with 15× Reduction and 200+ FPS. arXiv preprint arXiv:2311.17245 (2023), 1-16.
[10] Sharath Girish, Kamal Gupta, and Abhinav Shrivastava. 2023. EAGLES: Efficient Accelerated 3D Gaussians with Lightweight Encodings. arXiv preprint arXiv:2312.04564 (2023), 1-10.
[11] Abdullah Hamdi, Luke Melas-Kyriazi, Guocheng Qian, Jinjie Mai, Ruoshi Liu, Carl Vondrick, Bernard Ghanem, and Andrea Vedaldi. 2024. GES: Generalized Exponential Splatting for Efficient Radiance Field Rendering. arXiv preprint arXiv:2402.10128 (2024).
[12] Peter Hedman, Julien Philip, True Price, Jan-Michael Frahm, George Drettakis, and Gabriel Brostow. 2018. Deep Blending for Free-viewpoint Image-based Rendering. ACM Transactions on Graphics 37, 6 (2018), 1-15.
[13] Zhihua Hu, Bo Duan, Yanfeng Zhang, Mingwei Sun, and Jingwei Huang. 2022. MVLayoutNet: 3D Layout Reconstruction with Multi-view Panoramas. In Proceedings of the ACM International Conference on Multimedia. 1289-1298.
[14] Zhihao Hu, Dong Xu, Guo Lu, Wei Jiang, Wei Wang, and Shan Liu. 2022. FVC: An End-to-End Framework Towards Deep Video Compression in Feature Space. IEEE Transactions on Pattern Analysis and Machine Intelligence 45, 4 (2022), 4569-4585.
[15] Letian Huang, Jiayang Bai, Jie Guo, and Yanwen Guo. 2024. GS++: Error Analyzing and Optimal Gaussian Splatting. arXiv preprint arXiv:2402.00752 (2024), 1-18.
[16] Wei Jiang, Jiayu Yang, Yongqi Zhai, Peirong Ning, Feng Gao, and Ronggang Wang. 2023. MLIC: Multi-reference Entropy Model for Learned Image Compression. In Proceedings of the ACM International Conference on Multimedia. 7618-7627.
[17] Bernhard Kerbl, Georgios Kopanas, Thomas Leimkiihler, and George Drettakis. 2023. 3D Gaussian Splatting for Real-time Radiance Field Rendering. ACM Transactions on Graphics 42, 4 (2023), 1-14.
[18] Diederik P. Kingma and Jimmy Ba. 2015. Adam: A Method for Stochastic Optimization. In Proceedings of the International Conference on Learning Representations. 1-11.
[19] Arno Knapitsch, Jaesik Park, Qian-Yi Zhou, and Vladlen Koltun. 2017. Tanks and Temples: Benchmarking large-scale scene reconstruction. ACM Transactions on Graphics 36, 4 (2017), 1-13.
[20] Joo Chan Lee, Daniel Rho, Xiangyu Sun, Jong Hwan Ko, and Eunbyung Park. 2023. Compact 3D Gaussian Representation for Radiance Field. arXiv preprint arXiv:2311.13681(2023), 1-10.
[21] Deqi Li, Shi-Sheng Huang, Tianyu Shen, and Hua Huang. 2023. Dynamic View Synthesis with Spatio-Temporal Feature Warping from Sparse Views. In Proceedings of the ACM International Conference on Multimedia. 1565-1576.
[22] Jiahao Li, Bin Li, and Yan Lu. 2021. Deep Contextual Video Compression. In Proceedings of the Advances in Neural Information Processing Systems. 1811418125.
[23] Jiahao Li, Bin Li, and Yan Lu. 2022. Hybrid Spatial-temporal Entropy Modelling for Neural Video Compression. In Proceedings of the ACM International Conference on Multimedia. 1503-1511.
[24] Jiahao Li, Bin Li, and Yan Lu. 2023. Neural Video Compression with Diverse Contexts. In Proceedings of the IEEE/CVF Conference on Computer Vision and Pattern Recognition. 22616-22626.
[25] Li Li, Houqiang Li, Dong Liu, Zhu Li, Haitao Yang, Sixin Lin, Huanbang Chen, and Feng Wu. 2017. An Efficient Four-Parameter Affine Motion Model for Video Coding. IEEE Transactions on Circuits and Systems for Video Technology 28, 8 (2017), 1934-1948.
[26] Zhiqian Lin, Jiangke Lin, Lincheng Li, Yi Yuan, and Zhengxia Zou. 2022. Highquality 3D Face Reconstruction with Affine Convolutional Networks. In Proceedings of the ACM International Conference on Multimedia. 2495-2503.
[27] Tao Lu, Mulin Yu, Linning Xu, Yuanbo Xiangli, Limin Wang, Dahua Lin, and Bo Dai. 2023. Scaffold-GS: Structured 3D Gaussians for View-adaptive Rendering. arXiv preprint arXiv:2312.00109 (2023), 1-11.
[28] Ben Mildenhall, Pratul P Srinivasan, Matthew Tancik, Jonathan T Barron, Ravi Ramamoorthi, and Ren Ng. 2021. NeRF: Representing Scenes as Neural Radiance Fields for View Synthesis. Commun. ACM 65, 1 (2021), 99-106.
[29] David Minnen, Johannes Ballé, and George D Toderici. 2018. Joint Autoregressive and Hierarchical Priors for Learned Image Compression. In Proceedings of the Advances in Neural Information Processing Systems. 10771-10780.
[30] David Minnen and Saurabh Singh. 2020. Channel-wise Autoregressive Entropy Models for Learned Image Compression. In Proceedings of the IEEE International Conference on Image Processing. 3339-3343.
[31] Alistair Moffat, Radford M Neal, and Ian H Witten. 1998. Arithmetic Coding Revisited. ACM Transactions on Information Systems 16, 3 (1998), 256-294.
[32] Thomas Müller, Alex Evans, Christoph Schied, and Alexander Keller. 2022. Instant Neural Graphics Primitives with a Multiresolution Hash Encoding. ACM Transactions on Graphics 41, 4 (2022), 1-15.
[33] K L Navaneet, Kossar Pourahmadi Meibodi, Soroush Abbasi Koohpayegani, and Hamed Pirsiavash. 2023. Compact3D: Compressing Gaussian Splat Radiance Field Models with Vector Quantization. arXiv preprint arXiv:2311.18159 (2023), 1-12.
[34] Simon Niedermayr, Josef Stumpfegger, and Rudiger Westermann. 2023. Compressed 3D Gaussian Splatting for Accelerated Novel View Synthesis. arXiv preprint arXiv:2401.02436 (2023), 1-10.
[35] Adam Paszke, Sam Gross, Francisco Massa, Adam Lerer, James Bradbury, Gregory Chanan, Trevor Killeen, Zeming Lin, Natalia Gimelshein, Luca Antiga, et al. 2019. PyTorch: An Imperative Style, High-performance Deep Learning Library. In Proceedings of the Advances in Neural Information Processing Systems. 8026-8037.
[36] Johannes L Schonberger and Jan-Michael Frahm. 2016. Structure-from-motion Revisited. In Proceedings of the IEEE Conference on Computer Vision and Pattern Recognition. 4104-4113.
[37] Sebastian Schwarz, Marius Preda, Vittorio Baroncini, Madhukar Budagavi, Pablo Cesar, Philip A Chou, Robert A Cohen, Maja Krivokuda, Sebastien Lasserre, Zhu Li, et al. 2018. Emerging MPEG Standards for Point Cloud Compression. IEEE Journal on Emerging and Selected Topics in Circuits and Systems 9, 1 (2018), 133-148.
[38] Zhou Wang, Alan C Bovik, Hamid R Sheikh, and Eero P Simoncelli. 2004. Image Quality Assessment: From Error Visibility to Structural Similarity. IEEE Transactions on Image Processing 13, 4 (2004), 600-612.
[39] Wenpeng Xing and Jie Chen. 2022. MVSPlenOctree: Fast and Generic Reconstruction of Radiance Fields in PlenOctree from Multi-view Stereo. In Proceedings of the ACM International Conference on Multimedia. 5114-5122.
[40] Lior Yariv, Peter Hedman, Christian Reiser, Dor Verbin, Pratul P Srinivasan, Richard Szeliski, Jonathan T Barron, and Ben Mildenhall. 2023. BakedSDF: Meshing Neural SDFs for Real-time View Synthesis. In Proceedings of the ACM SIGGRAPH. 1-9.
[41] Zehao Yu, Anpei Chen, Binbin Huang, Torsten Sattler, and Andreas Geiger. 2023. Mip-Splatting: Alias-free 3D Gaussian Splatting. arXiv:2311.16493 (2023), 1-10.
[42] Richard Zhang, Phillip Isola, Alexei A Efros, Eli Shechtman, and Oliver Wang. 2018. The Unreasonable Effectiveness of Deep Features as a Perceptual Metric. In Proceedings of the IEEE Conference on Computer Vision and Pattern Recognition. 586-595.
[43] Zhaobin Zhang, Semih Esenlik, Yaojun Wu, Meng Wang, Kai Zhang, and Li Zhang. 2023. End-to-end Learning-based Image Compression with A Decoupled Framework. IEEE Transactions on Circuits and Systems for Video Technology (2023), 1-14.
[44] Matthias Zwicker, Hanspeter Pfister, Jeroen Van Baar, and Markus Gross. 2002. EWA Splatting. IEEE Transactions on Visualization and Computer Graphics 8, 3 (2002), 223-238.

### SUMMARY OF INVENTION

Accordingly, the present invention, in one aspect, is a computer-implemented method for representing 3D scenes. The method includes the steps of creating a plurality of first primitives, predicting a plurality of second primitives from the plurality of first primitives, and rendering 3D scenes based on the first and second primitives. The plurality of second primitives comprising residual embeddings.

In some embodiments, the plurality of first primitives includes geometry attributes and reference embeddings.

In some embodiments, the plurality of second primitives includes only the residual embeddings.

In some embodiments, the step of predicting a plurality of second primitives further includes obtaining geometry attributes of the plurality of second primitives by wrapping the plurality of first primitives via affine transform.

In some embodiments, affine parameters of the affine transform are adeptly predicted based on prediction features derived from the first and second primitives.

In some embodiments, the step of obtaining geometry attributes of the plurality of second primitives further includes fusing the reference embeddings of one first primitive and the residual embedding of a corresponding one of the second primitive by channel-wise concatenation to yield the prediction features, and deriving the affine parameters from the prediction features via learnable linear layers.

In some embodiments, the affine transform is performed to locations and covariances in geometry attributes of the plurality of first primitives to obtain locations and covariances of the plurality of second primitives.

In some embodiments, the affine parameters comprise a translation vector, a scaling matrix, and a rotation matrix, all of which predicted by neural networks.

In some embodiments, the step of predicting a plurality of second primitives further includes obtaining appearance attributes of the plurality of second primitives based on view embeddings and the prediction features.

In some embodiments, the view embeddings are generated from camera poses.

In some embodiments, the step of obtaining the appearance attributes further includes concatenating the view embeddings and the prediction features in a channel-wise way to obtain concatenated features, and predicting color and opacity as the appearance attributes from the concatenated features using neural networks.

In some embodiments, the method further incudes a step of optimizing the first and second primitives based on a rate-constrained optimization scheme.

In some embodiments, the rate-constrained optimization scheme utilizes a Lagrange multiplier for controlling a trade-off between rate and distortion.

In some embodiments, the step of optimizing the first and second primitives further includes conducting entropy estimation to the first and second primitives to model bitrates of the first and second primitives.

In some embodiments, the step of conducting entropy estimation further includes applying scalar quantization to reference embeddings and covariance in the plurality of first primitives, and to the residual embeddings of the plurality of second primitives; and estimating probability distributions of the reference embeddings, the covariance, and the residual embeddings.

In some embodiments, the step of applying scalar quantization further includes simulating rounding operators in the scalar quantization using quantization noises.

In some embodiments, in the step of estimating the probability distributions, the probability distributions are modelled by Gaussian distribution.

In some embodiments, in the step of rendering 3D scenes, the first and second primitives are used as 3D Gaussians. The step of rendering 3D scenes further includes mapping the 3D Gaussians to target views to render the 3D scenes.

In some embodiments, the step of mapping the 3D Gaussians to target views to render the 3D scenes are conducted via volume splatting.

According to another aspect of the invention, there is provided a non-transitory computer-readable memory recording medium having computer instructions recorded thereon. The computer instructions, when executed on one or more processors, cause the one or more processors to perform operations according to the method of representing 3D scenes or its variations as mentioned above.

According to a further aspect of the invention, there is provided a computing system which includes one or more processors, and memory containing instructions that, when executed by the one or more processors, cause the computing system to perform operations according to the method of representing 3D scenes or its variations as mentioned above.

According to a further embodiment of the invention, there is provided a method for compressing 3D scene representations using Gaussian primitives. The method includes the steps of utilizing a hybrid primitive structure with anchor and coupled primitives, encoding anchor primitives with full attribute information, predicting attributes of coupled primitives based on anchor primitives, and compressing coupled primitives into residual forms relative to the anchor primitives.

According to a further embodiment of the invention, there is provided a system for efficient 3D scene modeling and rendering. The system includes a compression module for reducing data size of 3D Gaussian primitives, a rendering module for high-quality view synthesis from compressed primitives, and an optimization scheme for balancing bitrate and representation efficacy.

According to a further embodiment of the invention, there is provided a computer-readable medium storing instructions that, when executed, perform operations for compressing 3D Gaussian primitives. The operations include initializing anchor primitives from a sparse point cloud, performing inter-primitive prediction to generate residual embeddings for coupled primitives, applying rate-distortion optimization to the hybrid primitive structure, and encoding the optimized primitives for storage or transmission.

According to a further embodiment of the invention, there is provided an apparatus for 3D scene rendering from compressed representations. The apparatus is capable of: decoding compressed anchor and coupled primitives, reconstructing full 3D Gaussians using predicted attributes and residual information, rendering high-quality 3D scenes with reduced computational resources, and achieving real-time rendering from compressed data sets.

According to a further embodiment of the invention, there is provided a technique for compressing 3D Gaussian splatting models using anchor and coupled primitives. The technique reduces the quantity of 3D Gaussians through predictive encoding. The technique applies quantization to attributes of retained Gaussians.

According to a further embodiment of the invention, there is provided a method for adaptive control of primitive quantity in 3D scene representation compression. The method adjusts the number of anchor primitives based on scene complexity, associates each anchor primitive with a variable number of coupled primitives, and optimizes the compression process for different 3D scenes.

According to a further embodiment of the invention, there is provided a module for efficient 3D scene compression, wherein the module includes a prediction network for the hybrid primitive structure. The prediction network generates affine parameters for warping anchor primitives. The module includes a rate-constrained optimization scheme for minimizing bitrate and distortion.

According to a further embodiment of the invention, there is provided a hybrid primitive structure for 3D scene representation. The structure includes a set of anchor primitives with full attribute information, a plurality of coupled primitives with compact residual embeddings, and a prediction mechanism for deriving attributes of coupled primitives from anchor primitives.

According to a further embodiment of the invention, there is provided a rate-constrained optimization scheme for 3D scene representation. The scheme includes an entropy estimation model for calculating bitrate of primitives, a rate-distortion loss function for end-to-end optimization of primitives, and a Lagrange multiplier for controlling the trade-off between rate and distortion.

According to a further embodiment of the invention, there is provided a method for inter-primitive prediction in 3D scene compression. The method includes fusing reference and residual embeddings to generate prediction features, using affine transform for geometry attribute prediction, and predicting view-dependent appearance attributes using concatenated features.

According to a further embodiment of the invention, there is provided a method for affine parameter prediction in 3D scene representation. The method includes decomposing affine parameters into translation, scaling, and rotation components, predicting each component using learnable neural networks, and applying the predicted parameters for warping anchor primitives.

According to a further embodiment of the invention, there is provided an algorithm for entropy estimation in the compression of 3D scene representations. The algorithm includes the quantization of anchor and coupled primitive attributes, modelling the probability distribution of quantized Gaussian attributes, predicting parameters for the probability distribution based on hyperpriors, and calculating the bitrate based on the estimated probability distribution.

According to a further embodiment of the invention, there is provided a method for rendering high-quality 3D scenes from compressed data. The method includes decoding compressed primitive attributes, and utilizing render techniques for novel view images. In one instance, the rendering techniques can be volume splatting. In one instance, the rendering techniques can be point-based rendering algorithms.

According to a further embodiment of the invention, there is provided a computer-implemented system for 3D scene compression and rendering. The system includes a predictor for estimating missing data from available primitive information, a decoder for decoding compressed 3D Gaussian primitives, a renderer for synthesizing novel views from decoded primitives, and an optimizer for adjusting information for hybrid primitive structure and networks.

According to a further embodiment of the invention, there is provided a computer-implemented system for 3D scene compression and rendering. The system includes a processor for executing compression and rendering algorithms, a memory for storing compressed primitive data, and an output device for displaying rendered 3D scenes.

According to a further embodiment of the invention, there is provided a method for achieving data reduction in 3D scene representation. The method includes identifying and utilizing local similarities among 3D Gaussians, applying predictive coding to reduce redundancies, and employing rate-distortion optimization for efficient bitrate allocation.

One can see that embodiments of the invention therefore provide systems and methods for 3D scene representation, which utilize compact primitives for efficient 3D scene representation with remarkably reduced size. In some embodiments, the invention tailors a hybrid primitive structure for compact scene modeling, wherein coupled primitives are proficiently predicted by a limited set of anchor primitives and thus, encapsulated into succinct residual embeddings. In some embodiments, a rate-constrained optimization scheme is provided to further improve the compactness of primitives. In this scheme, the primitive rate model is established via entropy estimation, and the rate-distortion cost is then formulated to optimize these primitives for an optimal trade-off between rendering efficacy and bitrate consumption. Incorporated with the hybrid primitive structure and rate-constrained optimization, this invention outperforms existing compression methods, achieving superior size reduction without compromising rendering quality.

The foregoing summary is neither intended to define the invention of the application, which is measured by the claims, nor is it intended to be limiting as to the scope of the invention in any way.

### BRIEF DESCRIPTION OF FIGURES

The foregoing and further features of the present invention will be apparent from the following description of embodiments which are provided by way of example only in connection with the accompanying figures, of which:

FIG. 1 shows a comparison between a 3D scene representation method according to a first embodiment of the invention and some conventional Gaussian splatting compression methods.

FIG. 2 shows an illustration of local similarities of 3D Gaussians.

FIG. 3 shows details of modules and method steps involved in the 3D scene representation method according to the first embodiment of the invention.

FIG. 4 illustrates the inter-primitive prediction of the method of FIG. 3 in detail.

FIG. 5 illustrates the entropy estimation used in the method of FIG. 3, where H denotes the hyper encoder [2] to produce hyperpriors and Q denotes the quantizer.

FIG. 6a shows the rate-distortion curves of the method of FIG. 3 and comparison methods [10,17,20,33,34] over the Tanks&Temples dataset [19].

FIG. 6b shows the rate-distortion curves of the method of FIG. 3 and comparison methods [10,17,20,33,34] over the Deep Blending [12] dataset.

FIG. 6c shows the rate-distortion curves of the method of FIG. 3 and comparison methods [10,17,20,33,34] over the Mip-NeRF 360 [4] dataset.

FIG. 7 shows qualitative results of the method in FIG. 3 compared to existing compression methods [10, 20, 33, 34].

FIG. 8 illustrates bitstream analysis at multiple bitrate points.

FIG. 9 is a block diagram of an example computing device suitable for use in implementing some embodiments of the invention.

### DETAILED DESCRIPTION

As will be explained in more details below, in one exemplary embodiment of the invention there is provided a Compressed Gaussian Splatting (CompGS) for efficient 3D scene representation, which leverages compact primitives to proficiently characterize 3D scenes, and achieves an impressive compression ratio up to 110× on prevalent datasets. As such, faithful 3D scene modeling can be achieved with a remarkably reduced data size. For this purpose, inspired by the correlations among 3D Gaussians depicted in FIG. 2, a hybrid primitive structure is introduced to facilitate compactness, wherein the majority of primitives are adeptly predicted by a limited number of anchor primitives, thus allowing compact residual representations. In FIG. 2, the local similarity is measured by the average cosine distances between a 3D Gaussian and its 20 neighbors with minimal Euclidean distance. In addition, a rate-constrained optimization scheme is used to further prompt the compactness of primitives via joint minimization of rendering distortion and bitrate costs, fostering an optimal trade-off between bitrate consumption and representation efficiency.

To ensure the compactness of Gaussian primitives, the hybrid primitive structure captures predictive relationships between each other. Then, a small set of anchor primitives is exploited for prediction, allowing the majority of primitives to be encapsulated into highly compact residual forms. Moreover, the rate-constrained optimization scheme is designed to eliminate redundancies within such hybrid primitives, steering the CompGS towards an optimal trade-off between bitrate consumption and representation efficacy. Experimental results show that the CompGS significantly outperforms existing methods, achieving superior compactness in 3D scene representation without compromising model accuracy and rendering quality.

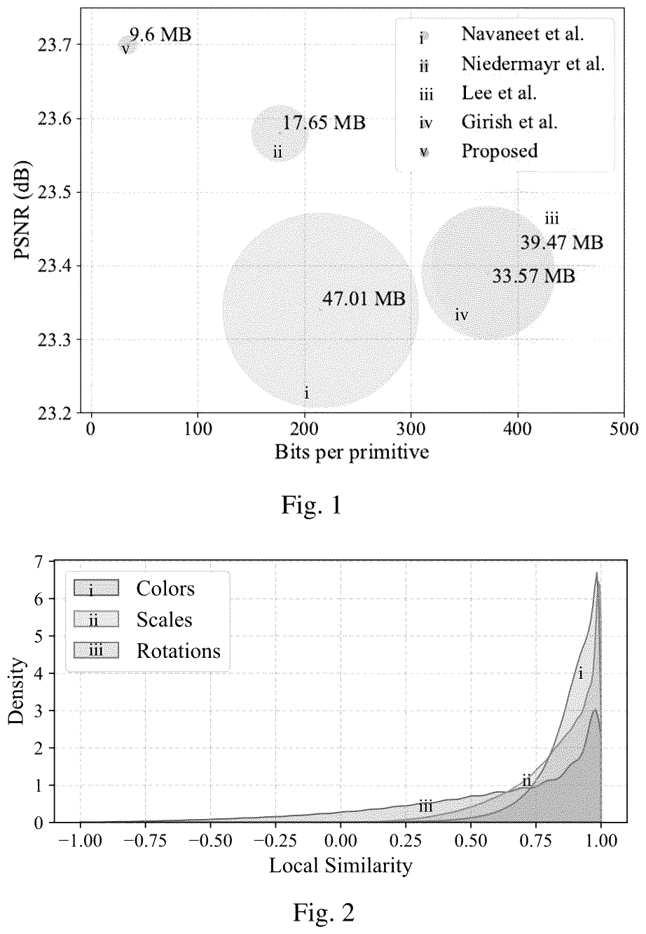

Existing compression methods for 3DGS fail to exploit the intrinsic characteristics within 3D Gaussians, leading to inferior compression efficacy, as shown in FIG. 1 with examples of prior works [10, 20, 33, 34]. In comparison, owing to the hybrid primitive structure and the rate-constrained optimization scheme, the CompGS (labelled as “Proposed” in FIG. 1) achieves not only high-quality rendering but also compact representations compared to those prior works [10, 20, 33, 34] based on the Tanks&Temples dataset [19], as shown in FIG. 1. Comparison metrics include rendering quality in terms of PSNR, model size and bits per primitive.

Next, conventional Gaussian splatting scene representation will be briefly described. The 3DGS is a technique for 3D scene representation which leverages explicit primitives to model 3D scenes and renders scenes by projecting these primitives onto target views. Specifically, 3DGS characterizes primitives by 3D Gaussians initialized from a sparse point cloud and then optimizes these 3D Gaussians to accurately represent a 3D scene. Each 3D Gaussian encompasses geometry attributes, i.e., location and covariance, to determine its spatial location and shape. Moreover, appearance attributes, including opacity and color, are involved in the 3D Gaussian to attain pixel intensities when projected to a specific view. Subsequently, the differentiable and highly parallel volume splatting pipeline [44] as one possible rendering method is incorporated to render view images by mapping 3D Gaussians to the specific view, followed by the optimization of 3D Gaussians via rendering distortion minimization. Meanwhile, an adaptive control strategy is devised to adjust the amount of 3D Gaussians, wherein insignificant 3D Gaussians are pruned while crucial ones are densified. Some methods have been proposed to compress models of 3DGS, relying on heuristic pruning strategies to reduce the number of 3D Gaussians and quantization to discretize attributes of 3D Gaussians into compact codewords. However, these existing methods optimize 3D Gaussians merely by minimizing rendering distortion, and then independently compress each 3D Gaussian, thus leaving substantial redundancies within obtained 3D scene representations.

On the other hand, Video coding, an outstanding data compression research field, has witnessed remarkable advancements over the past decades and cultivated numerous invaluable coding technologies. The most advanced traditional video coding standard, versatile video coding (VVC) [6], employs a hybrid coding framework, capitalizing on predictive coding and rate-distortion optimization to effectively reduce redundancies within video sequences. Specifically, predictive coding is devised to harness correlations among pixels to perform prediction. Subsequently, only the residues between the original and predicted values are encoded, thereby reducing pixel redundancies and enhancing compression efficacy. Notably, VVC [6] employs affine transform [25] to improve prediction via modeling non-rigid motion between pixels. Furthermore, VVC [6] employs rate-distortion optimization to adaptively configure coding tools, hence achieving superior coding efficiency.

Recently, neural video coding has emerged as a competitive alternative to traditional video coding. These methods adhere to the hybrid coding paradigm, integrating neural networks for both prediction and subsequent residual coding. Meanwhile, end-to-end optimization is employed to optimize neural networks within compression frameworks via rate-distortion cost minimization. Within the neural video coding pipeline, entropy models, as a vital component of residual coding, are continuously improved to accurately estimate the probabilities of residues and, thus, the rates. Motivated by the advancements of video coding, the CompGS therefore employs the philosophy of both prediction and rate-distortion optimization to effectively eliminate redundancies within the primitives.

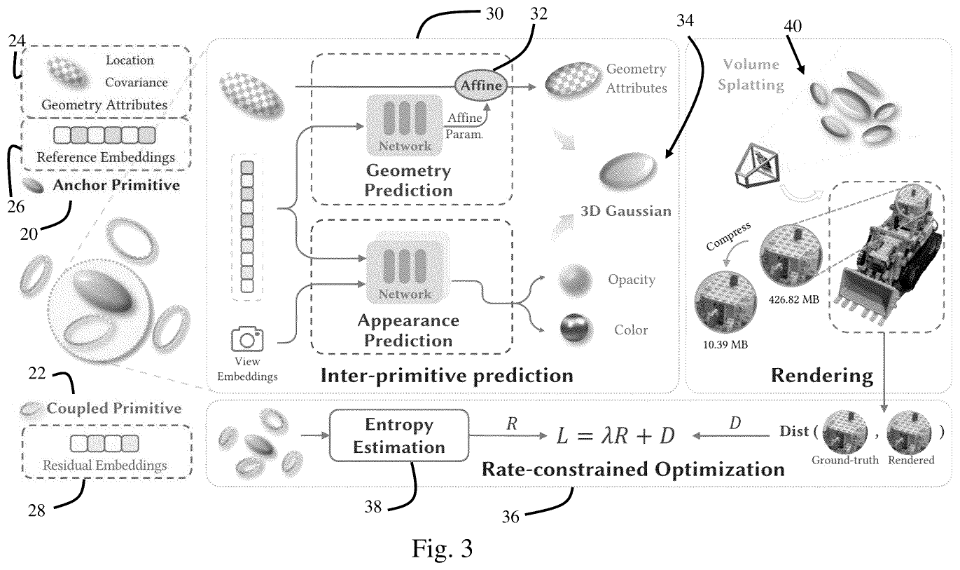

In the following section, the CompGS will be described in detail with respect to its modules and method steps. As mentioned above, the CompGS encompasses a hybrid primitive structure for compact 3D scene representation (see FIG. 3), involving anchor primitives 20 to predict attributes of the remaining coupled primitives 22. Specifically, a limited number of anchor primitives 22 are created as references, for example from a sparse point cloud. Each anchor primitive ω is embodied by geometry attributes 24 (location μ_{ω} and covariance Σ_{ω}) and reference embeddings ƒ_{ω} (denoted by number 26). Then, ω is associated with a set of K coupled primitives {γ₁, . . . , γ_{K}}, and each coupled primitive γₖ only includes compact residual embeddings gₖ (denoted by number 28) to compensate for prediction errors. In the subsequent inter-primitive prediction 30, the geometry attributes of γₖ are obtained by warping the corresponding anchor primitive ω via affine transform 32, wherein affine parameters are adeptly predicted by ƒ_{ω} and gₖ. Concurrently, the view-dependent appearance attributes of γₖ, i.e., color and opacity, are predicted using {ƒ_{ω}, gₖ} and view embeddings [27]. Owing to the hybrid primitive structure, the proposed CompGS can compactly model 3D scenes by redundancy-eliminated primitives, with the majority of primitives presented in residual forms.

Once attaining geometry and appearance attributes, these coupled primitives 22 can be utilized as 3D Gaussians 34 to render view images via volume splatting [28](denoted by number 40). In the subsequent rate-constrained optimization 36, rendering distortion D can be derived by calculating the quality degradation between the rendered and corresponding ground-truth images. Additionally, entropy estimation 38 is exploited to model the bitrate of anchor primitives and associated coupled primitives. The derived bitrate R, along with the distortion D, are used to formulate the rate-distortion cost [symbol] . Then, all primitives within the CompGS are jointly optimized via rate-distortion cost minimization, which facilitates the primitive compactness and, thus, compression efficiency. The optimization process of the primitives can be formulated by

$${Ω}^{*} , {Γ}^{*} = {arg min ℒ}_{Ω , Γ} = {arg min}_{Ω , Γ} λR + D , \qquad ( 1 )$$

where λ denotes the Lagrange multiplier to control the trade-off between rate and distortion, and {Ω, Γ} denote the set of anchor primitives and coupled primitives, respectively.

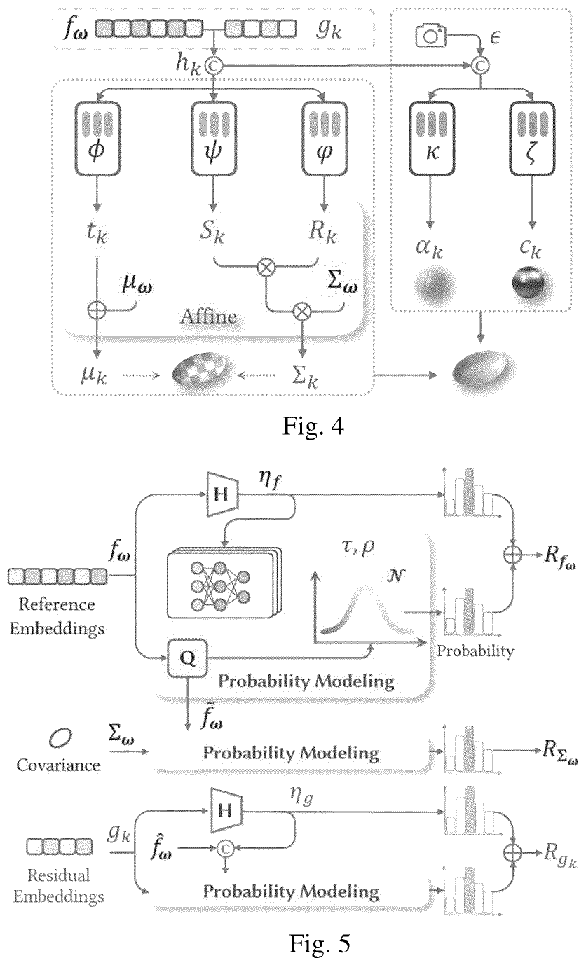

As mentioned above, the inter-primitive prediction performed by the CompGS is to derive the geometry and appearance attributes of coupled primitives based on associated anchor primitives. As a result, coupled primitives only necessitate succinct residues, contributing to compact 3D scene representation. As shown in FIG. 4, the inter-primitive prediction takes an anchor primitive ω and an associated coupled primitive γ_k as inputs, and predicts geometry and appearance attributes for γₖ, including location μₖ, covariance Σₖ, opacity αₖ, and color cₖ. Specifically, residual embeddings gₖ of γₖ and reference embeddings ƒ_{ω} of ω are first fused by channel-wise concatenation, yielding prediction features hₖ. Subsequently, the geometry attributes {μₖ, Σₖ} are generated by warping ω using affine transform [25], with the affine parameters βₖ derived from hₖ via learnable linear layers. This process can be formulated as

$${μ}_{k} , {\sum }_{k} = 𝒜 ( {μ}_{ω} , {\sum }_{ω} \vert {β}_{k} ) , \qquad ( 2 )$$

where [symbol] denotes the affine transform, and {μ_{ω}, Σ_{ω}} denote location and covariance of the anchor primitive ω, respectively. To improve the accuracy of geometry prediction, βₖ is further decomposed into translation vector tₖ, scaling matrix Sₖ, and rotation matrix Rₖ, which are predicted by neural networks, respectively, i.e.,

$${t}_{k} = ϕ ( {h}_{k} ) , {S}_{k} = ψ ( {h}_{k} ) , {R}_{k} = φ ( {h}_{k} ) , \qquad ( 3 )$$

where {φ(·),ψ(·),φ(·)} denote the neural networks. Correspondingly, the affine process in Equation (2) can be further formulated as

$${μ}_{k} = {μ}_{ω} + {t}_{k} , {\sum }_{k} = {S}_{k} {R}_{k} {\sum }_{ω} . \qquad ( 4 )$$

Simultaneously, to model the view-dependent appearance attributes αₖ and cₖ, view embeddings ϵ are generated from camera poses and concatenated with prediction features hₖ. Then, neural networks are employed to predict αₖ and cₖ based on the concatenated features. This process can be formulated by

$${α}_{k} = κ ( ϵ ⊕ {h}_{k} ) , {c}_{k} = ζ ( ϵ ⊕ {h}_{k} ) , \qquad ( 5 )$$

where ⊕ denotes the channel-wise concatenation and {κ(·),ξ(·)} denote the neural networks for color and opacity prediction, respectively.

Next, the rate-constrained optimization scheme used in the CompGS will be described. The scheme is devised to achieve compact primitive representation via joint minimization of bitrate consumption and rendering distortion. As shown in FIG. 5, the entropy estimation is established to effectively model the bitrate of both anchor and coupled primitives. Specifically, scalar quantization [1] is first applied to {Σ_{ω},ƒ_{ω}} of anchor primitive ω and gₖ of associated coupled primitive γₖ, i.e.,

$${\hat{\sum }}_{ω} = Q ( \frac{{\sum }_{ω}}{{s}_{\sum }} ) , {\hat{f}}_{ω} = Q ( \frac{{f}_{ω}}{{s}_{f}} ) , {\hat{g}}_{k} = Q ( \frac{{g}_{k}}{{s}_{g}} ) , \qquad ( 6 )$$

where Q(·) denotes the scalar quantization and {s_{Σ},s_{ƒ},s_{g}} denote the corresponding quantization steps. However, the rounding operator within Q is not differentiable and breaks the back-propagation chain of optimization. Hence, quantization noises [1] are utilized to simulate the rounding operator, yielding differentiable approximations as

$${\tilde{\sum }}_{ω} = {δ}_{\sum } + \frac{{\sum }_{ω}}{{s}_{\sum }} , {\tilde{f}}_{ω} = {δ}_{f} + \frac{{f}_{ω}}{{s}_{f}} , {\tilde{g}}_{k} = {δ}_{f} + \frac{{g}_{k}}{{s}_{g}} , \qquad ( 7 )$$

where {δ_{Σ}, δ_{ƒ}, δ_{g}} denote the quantization noises obeying uniform distributions. Subsequently, the probability distribution of \tilde{ƒ}_{ω} is estimated to calculate the corresponding bitrate. In this process, the probability distribution p(\tilde{ƒ}_{ω}) is parametrically formulated as a Gaussian distribution [symbol] (τ_{ƒ}, ρ_{ƒ}), where the parameters {τ_{ƒ}, ρ_{ƒ}} are predicted based on hyperpriors [2] extracted from ƒ_{ω}, i.e.,

$$p ( {\tilde{f}}_{ω} ) = 𝒩 ( {τ}_{f} , {ρ}_{f} ) , with {τ}_{f} , {ρ}_{f} = {ε}_{f} ( {η}_{f} ) \qquad ( 8 )$$

where ε_{ƒ} denotes the parameter prediction network and η_{ƒ} denotes the hyperpriors. Moreover, the probability of hyperpriors η_{ƒ} is estimated by the factorized entropy bottleneck [1], and the bitrate of ƒ_{ω} can be calculated by

$${R}_{{f}_{ω}} = {𝔼}_{ω} [ - log p ( {\tilde{f}}_{ω} ) - log p ( {η}_{f} ) ] \qquad ( 9 )$$

where p(η_{ƒ}) denotes the estimated probability of hyperpriors η_{ƒ}. Furthermore, \tilde{ƒ}ω is used as contexts to model the probability distributions of \tilde{Σ}_{ω} and \tilde{g}ₖ. Specifically, the probability distribution of \tilde{Σ}_{ω} is modeled by Gaussian distribution with parameters {τ_{Σ}, ρ_{Σ}} predicted by \tilde{ƒ}_{ω}, i.e.,

$$p ( \tilde{{\sum }_{ω}} ) = 𝒩 ( {τ}_{\sum } , {ρ}_{\sum } ) , with {τ}_{\sum } , {ρ}_{\sum } = {ε}_{\sum } ( {\tilde{f}}_{ω} ) \qquad ( 10 )$$

where p(\tilde{Σ}_{ω}) denotes the estimated probability distribution and ε_{Σ} denotes the parameter prediction network for covariance.

Meanwhile, considering the correlations between the ƒ_{ω} and gₖ, the probability distribution of \tilde{g}ₖ is modeled via Gaussian distribution conditioned on \tilde{ƒ}_{ω} and extracted hyperpriors η_{g}, i.e.,

$$p ( \tilde{{g}_{k}} ) = 𝒩 ( {τ}_{g} , {ρ}_{g} ) , with {τ}_{g} , {ρ}_{g} = {ε}_{g} ( {\tilde{f}}_{ω} ⊕ {η}_{g} ) \qquad ( 11 )$$

where p(\tilde{g}ₖ) denotes the estimated probability distribution. Accordingly, the bitrate of Σ_{ω} and gₖ can be calculated by

$${R}_{{\sum }_{ω}} = {𝔼}_{ω} [ - log p ( {\tilde{\sum }}_{ω} ) ] \qquad ( 12 )$$

where p(η_{g}) denotes the probability of η_{g} estimated via the factorized entropy bottleneck [1]. Consequently, the bitrate consumption of the anchor primitive ω and its associated K coupled primitives {γ₁, . . . , γ_{K}} can be further calculated by

$${R}_{ω , γ} = {R}_{{f}_{ω}} + {R}_{{\sum }_{ω}} + {\sum }_{k = 1}^{K} {R}_{{g}_{k}} \qquad ( 13 )$$

Furthermore, to formulate the rate-distortion cost depicted in Equation (1), the rate item R is calculated by summing bitrate costs of all anchor and coupled primitives, and the distortion item D is provided by the rendering loss [17]. Then, the rate-distortion cost is used to perform end-to-end optimization of primitives and neural networks within the CompGS, thereby attaining high-quality rendering under compact representations.

Next, implementation details of an exemplary implementation of the method in FIG. 3 are described. In the exemplary implementation, the dimension of reference embeddings is set to 32, and that of residual embeddings is set to 8. Neural networks used in both prediction and entropy estimation are implemented by two residual multi-layer perceptrons. Quantization steps {s_{ƒ},s_{g}} are fixed to 1, whereas s_{Σ} is a learnable parameter with an initial value of 0.01. The Lagrange multiplier λ in Equation (1) is set to {0.001,0.005,0.01} to obtain multiple bitrate points. Moreover, the anchor primitives are initialized from sparse point clouds produced by voxel-downsampled SfM points [36], and each anchor primitive is associated with K=10 coupled primitives. After the optimization, reference embeddings and covariance of anchor primitives, along with residual embeddings of coupled primitives, are compressed into bitstreams by arithmetic coding [31], wherein the probability distributions are provided by the entropy estimation module. Additionally, point cloud codec G-PCC [37] is employed to compress locations of anchor primitives.

The CompGS in the exemplary implementation is implemented based on PyTorch [35] and CompressAI [5] libraries. Adam optimizer [18] is used to optimize parameters of the proposed method, with a cosine annealing strategy for learning rate decay. Additionally, adaptive control [27] is applied to manage the number of anchor primitives, and the volume splatting [44] is implemented by custom CUDA kernels [17].

To comprehensively evaluate the effectiveness of the CompGS, experiments are conducted using the above-described exemplary implementation on three prevailing view synthesis datasets, including Tanks&Temples [19], Deep Blending [12] and Mip-NeRF 360 [4]. These datasets contain high-resolution multiview images collected from real-world scenes, characterized by unbounded environments and intricate objects. Furthermore, the experimental protocols in 3DGS [17] are conformed to, so as to ensure evaluation fairness. Specifically, the scenes specified by 3DGS [17] are involved in evaluations, and the sparse point clouds provided by 3DGS [17] are utilized to initialize the anchor primitives. Additionally, one view is selected from every eight views for testing, with the remaining views used for training.

3DGS [17] is employed as an anchor method and compare several concurrent compression methods [10, 20,33,34]. To retrain these models for fair comparison, their default configurations as prescribed in corresponding papers are adhered to. Notably, extant compression methods [10, 20, 33, 34] only provide the configuration for a single bitrate point. Moreover, each method undergoes five independent evaluations in a consistent environment to mitigate the effect of randomness, and the average results of the five experiments are reported. Regarding the evaluation metrics, PSNR, SSIM [38] and LPIPS [42] are adopted to evaluate the rendering quality, alongside model size, for assessing compression efficiency. Meanwhile, training, encoding, decoding, and view-average rendering time are used to quantitatively compare the computational complexity across various methods.

TABLE 1
Performance comparison on the Tanks&Temples dataset [19].

| | PSNR | | | Size |
|---|---|---|---|---|
| Methods | (dB) | SSIM | LPIPS | (MB) |
| Kerbl et al. [17] | 23.72 | 0.85 | 0.18 | 434.38 |
| Navaneet et al. [33] | 23.34 | 0.84 | 0.19 | 47.01 |
| Niedermayr et al. [34] | 23.58 | 0.85 | 0.19 | 17.65 |
| Lee et al. [20] | 23.40 | 0.84 | 0.20 | 39.47 |
| Girish et al. [10] | 23.39 | 0.84 | 0.20 | 33.57 |
| Proposed-high | 23.70 | 0.84 | 0.21 | 9.60 |
| Proposed-medium | 23.39 | 0.83 | 0.22 | 7.27 |
| Proposed-low | 23.11 | 0.81 | 0.24 | 5.89 |

Looking at the experimental results, one can see that CompGS achieves the highest compression efficiency on the Tanks&Temples dataset [19], as illustrated in Table 1. Specifically, compared with 3DGS [17], the CompGS (denoted as “Proposed” in Table 1 as well as other tables) achieves a significant compression ratio, ranging from 45.25× to 73.75×, with a size reduction up to 428.49 MB. These results highlight the effectiveness of the CompGS. Moreover, the CompGS surpasses existing compression methods [10, 20, 33, 34], with the highest rendering quality, i.e., 23.70 dB, and the smallest bitstream size. This advancement stems from comprehensive utilization of the hybrid primitive structure and the rate-constrained optimization, which effectively facilitate compact representations of 3D scenes.

TABLE 2
Performance comparison on the Deep Blending dataset [12].

| | PSNR | | | Size |
|---|---|---|---|---|
| Methods | (dB) | SSIM | LPIPS | (MB) |
| Kerbl et al. [17] | 29.54 | 0.91 | 0.24 | 665.99 |
| Navaneet et al. [33] | 29.89 | 0.91 | 0.25 | 72.46 |
| Niedermayr et al. [34] | 29.45 | 0.91 | 0.25 | 23.87 |
| Lee et al. [20] | 29.82 | 0.91 | 0.25 | 43.14 |
| Girish et al. [10] | 29.90 | 0.91 | 0.25 | 61.69 |
| Proposed-high | 29.69 | 0.90 | 0.28 | 8.77 |
| Proposed-medium | 29.40 | 0.90 | 0.29 | 6.82 |
| Proposed-low | 29.30 | 0.90 | 0.29 | 6.03 |

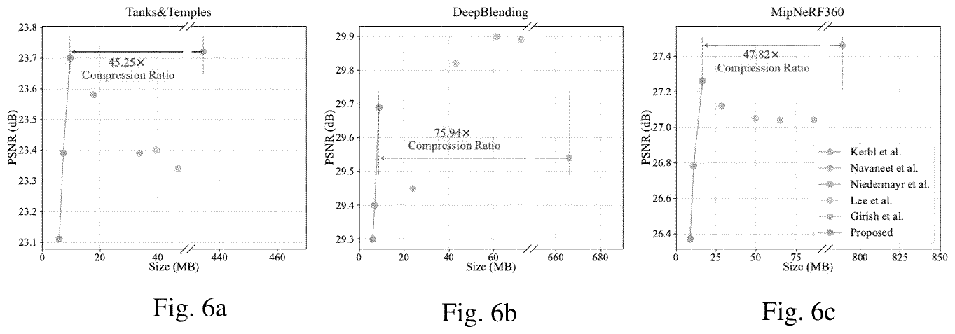

Table 2 shows the quantitative results on the Deep Blending dataset [12]. Compared with 3DGS [17], the CompGS achieves remarkable compression ratios, from 75.94× to 110.45×. Meanwhile, the CompGS realizes a 0.15 dB improvement in rendering quality at the highest bitrate point, potentially attributed to the integration of feature embeddings and neural networks. Furthermore, the CompGS achieves further bitrate savings compared to existing compression methods [10, 20, 33, 34]. Consistent results are observed on the Mip-NeRF 360 dataset [4], wherein the CompGS considerably reduces the bitrate consumption, down from 788.98 MB to at most 16.50 MB, correspondingly, culminating in a compression ratio up to 89.35×. Additionally, the CompGS demonstrates a remarkable improvement in bitrate consumption over existing methods [10, 20, 33, 34]. Notably, within the Stump scene of the Mip-NeRF 360 dataset [4], the CompGS significantly reduces the model size from 1149.30 MB to 6.56 MB, achieving an extraordinary compression ratio of 175.20×. This exceptional outcome demonstrates the effectiveness of the CompGS and its potential for practical implementation of Gaussian splatting schemes. Moreover, the rate-distortion curves are presented to intuitively demonstrate the superiority of the CompGS. It can be observed from FIGS. 6a-6c that the CompGS achieves remarkable size reduction and competitive rendering quality as compared to other methods [10, 17, 20, 33, 34].

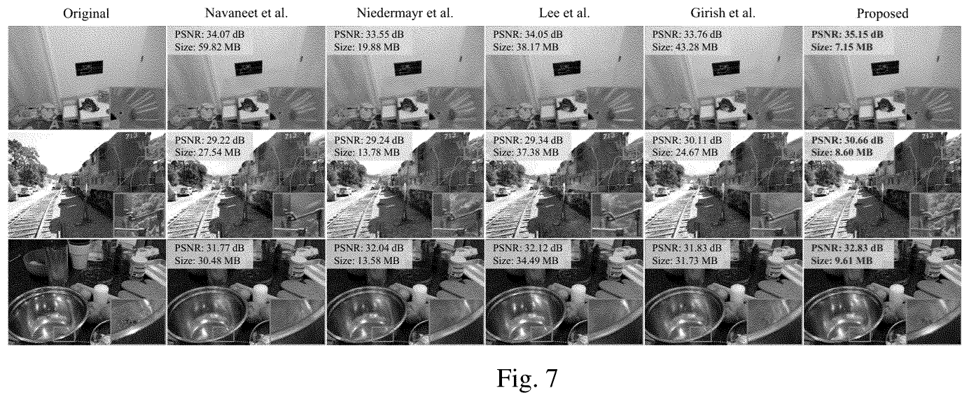

FIG. 7 illustrates the qualitative comparison of the CompGS and other compression methods [10,20,33,34], with specific details zoomed in. It can be observed that the rendered images obtained by the CompGS exhibit clearer textures and edges.

TABLE 4
Ablation studies on the Tanks&Temples dataset [19].

| Hybrid | Rate- | Train | | | | Truck | | | |
|---|---|---|---|---|---|---|---|---|---|
| Primitive | constrained | PSNR | | | Size | PSNR | | | Size |
| Structure | Optimization | (dB) | SSIM | LPIPS | (MB) | (dB) | SSIM | LPIPS | (MB) |
| x | x | 22.02 | 0.81 | 0.21 | 257.44 | 25.41 | 0.88 | 0.15 | 611.31 |
| ✓ | x | 22.15 | 0.81 | 0.23 | 48.58 | 25.20 | 0.86 | 0.19 | 30.38 |
| ✓ | ✓ | 22.12 | 0.80 | 0.23 | 8.60 | 25.28 | 0.87 | 0.18 | 10.61 |

To verify the effectiveness of the hybrid primitive structure, it is incorporated into the baseline 3DGS [17], and the corresponding results on the Tanks&Temples dataset [19] are depicted in Table 4. It can be observed that the hybrid primitive structure greatly prompts the compactness of 3D scene representations, exemplified by a reduction of bitstream size from 257.44 MB to 48.58 MB for the Train scene and from 611.31 MB down to 30.38 MB for the Truck scene. This is because the devised hybrid primitive structure can effectively eliminate the redundancies among primitives, thus achieving compact 3D scene representation.

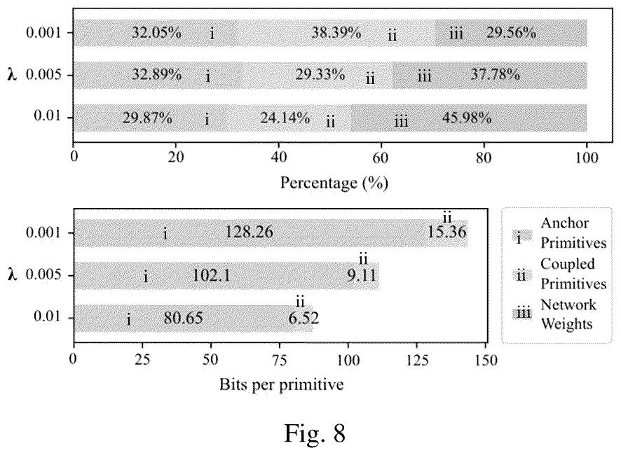

Furthermore, bitstream analysis of the CompGS on the Train scene is provided in FIG. 8. In FIG. 8, the upper figure illustrates the proportion of different components within bitstreams, and the bottom figure quantifies the bit consumption per anchor primitive and per coupled primitive. It can be observed that the bit consumption of coupled primitives is close to that of anchor primitives across multiple bitrate points, despite the significantly higher number of coupled primitives compared to anchor primitives. Notably, the average bit consumption of coupled primitives is demonstrably lower than that of anchor primitives, which benefits from the compact residual representation employed by the coupled primitives. These findings further underscore the superiority of the hybrid primitive structure in achieving compact 3D scene representation.

The rate-constrained optimization is devised to effectively improve the compactness of the primitives via minimizing the rate-distortion loss. To evaluate its effectiveness, the rate-constrained optimization is incorporated with the hybrid primitive structure, establishing the framework of the CompGS. As shown in Table 4, the employment of rate-constrained optimization leads to a further reduction of the bitstream size from 48.58 MB to 8.60 MB for the Train scene, equal to an additional bitrate reduction of 82.30%. On the Truck scene, a substantial decrease of 65.08% in bitrate is achieved. The observed bitrate efficiency can be attributed to the capacity of the CompGS to learn compact primitive representations through rate-constrained optimization.

Recent work [27] introduces a primitive derivation paradigm, whereby anchor primitives are used to generate new primitives. To demonstrate the superiority of the CompGS over this paradigm, a variant is devised, named “w.o. Res. Embed.”, which adheres to such primitive derivation paradigm [27] by removing the residual embeddings within coupled primitives. The experimental results on the Train scene of Tanks&Temples dataset [19], as shown in Table 5, reveal that, this variant fails to obtain satisfying rendering quality and inferiors to the CompGS. This is because such indiscriminate derivation of coupled primitives can hardly capture unique characteristics of coupled primitives. In contrast, the CompGS can effectively represent such characteristics by compact residual embeddings.

TABLE 5
Ablation studies on the residual embeddings.

| | PSNR | | | Size |
|---|---|---|---|---|
| | (dB) | SSIM | LPIPS | (MB) |
| w.o. | 20.50 | 0.73 | 0.31 | 5.75 |
| Res. Embed. | | | | |
| Proposed | 21.49 | 0.78 | 0.26 | 5.51 |

Ablations are conducted on the Train scene from the Tanks&Temples dataset [19] to investigate the impact of the proportion of coupled primitives. Specifically, the proportion of coupled primitives is adjusted by manipulating the number of coupled primitives K associated with each anchor primitive. As shown in Table 6, the case with K=10 yields the best rendering quality, which prompts setting K to 10 in the experiments. Besides, the increase of K from 10 to 15 leads to a rendering quality degradation of 0.22 dB. This might be because excessive coupled primitives could lead to an inaccurate prediction.

TABLE 7
Complexity comparison on the Tanks&Temples dataset [19].

| | Train | Enc-time | Dec-time | Render |
|---|---|---|---|---|
| Methods | (min) | (s) | (s) | (ms) |
| Navaneet et al. [33] | 14.38 | 68.29 | 12.32 | 9.88 |
| Niedermayr et al. [34] | 15.50 | 2.23 | 0.25 | 9.74 |
| Lee et al. [20] | 44.70 | 1.96 | 0.18 | 6.60 |
| Girish et al. [10] | 8.95 | 0.54 | 0.64 | 6.96 |
| Proposed | 37.83 | 6.27 | 4.46 | 5.32 |

Table 7 reports the complexity comparisons between the CompGS and existing compression methods [10, 20, 33, 34] on the Tanks&Temples dataset [19]. In terms of training time, the CompGS requires an average of 37.83 minutes for training, which is shorter than the method proposed by Lee et al. [20] and longer than other methods. This might be attributed to that the proposed method needs to optimize both primitives and neural networks. Additionally, the encoding and decoding times of the proposed method are both less than 10 seconds, which illustrates the practicality of the proposed method for real-world applications. In line with comparison methods, the per-view rendering time of the proposed method averages 5.32 milliseconds, due to the utilization of highly-parallel splatting rendering algorithm [44].

In summary, one can see that the above-mentioned exemplary embodiment offer several distinct advantages over existing technologies in the market for 3D scene representation. Firstly, it achieves a remarkable reduction in data size through the use of compact Gaussian primitives, which is particularly beneficial for applications requiring efficient storage and transmission of 3D data. Secondly, the hybrid primitive structure and rate-constrained optimization scheme allow for a more effective balance between bitrate consumption and representation efficacy, leading to better trade-off that is not commonly addressed in current solutions. Thirdly, the method's ability to exploit local similarities and predictive relationships between primitives results in a more sophisticated compression approach that significantly outperforms traditional techniques, particularly in rendering complex and realistic 3D scenes. Lastly, the method achieves superior size reduction while maintaining high-quality rendering, thus providing a superior visual experience compared to other compression methods that may sacrifice quality for compression efficiency. This makes the method highly suitable for advanced applications such as virtual reality, augmented reality, and high-fidelity 3D visualization where both compactness and quality are paramount.

The exemplary embodiments are thus fully described. Although the description referred to particular embodiments, it will be clear to one skilled in the art that the invention may be practiced with variation of these specific details. Hence this invention should not be construed as limited to the embodiments set forth herein.

While the embodiments have been illustrated and described in detail in the drawings and foregoing description, the same is to be considered as illustrative and not restrictive in character, it being understood that only exemplary embodiments have been shown and described and do not limit the scope of the invention in any manner. It can be appreciated that any of the features described herein may be used with any embodiment. The illustrative embodiments are not exclusive of each other or of other embodiments not recited herein. Accordingly, the invention also provides embodiments that comprise combinations of one or more of the illustrative embodiments described above. Modifications and variations of the invention as herein set forth can be made without departing from the spirit and scope thereof, and, therefore, only such limitations should be imposed as are indicated by the appended claims.

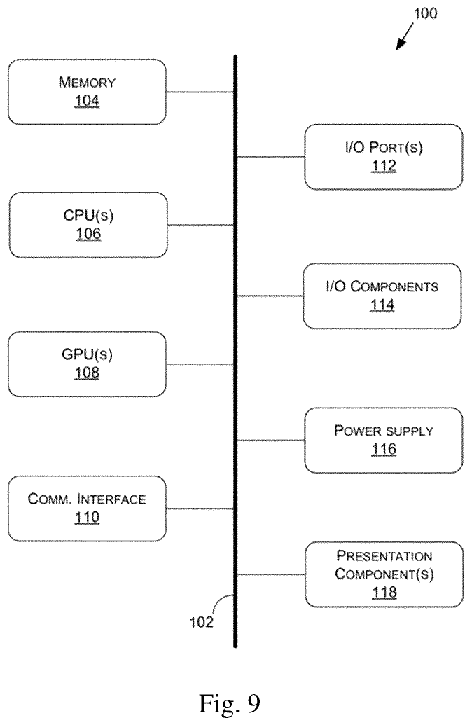

FIG. 9 is a block diagram of an example computing device 100 suitable for use in implementing some embodiments of the present disclosure. Computing device 100 may include a bus 102 that directly or indirectly couples the following devices: memory 104, one or more central processing units (CPUs) 106, one or more graphics processing units (GPUs) 108, a communication interface 110, input/output (I/O) ports 112, input/output components 114, a power supply 116, and one or more presentation components 118 (e.g., display(s)).

Although the various blocks of FIG. 9 are shown as connected via the bus 102 with lines, this is not intended to be limiting and is for clarity only. For example, in some embodiments, a presentation component 118, such as a display device, may be considered an I/O component 114 (e.g., if the display is a touch screen). As another example, the CPUs 106 and/or GPUs 108 may include memory (e.g., the memory 104 may be representative of a storage device in addition to the memory of the GPUs 108, the CPUs 106, and/or other components). In other words, the computing device of FIG. 9 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 9.

The bus 102 may represent one or more busses, such as an address bus, a data bus, a control bus, or a combination thereof. The bus 102 may include one or more bus types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus.

The memory 104 may include any of a variety of computer-readable media. The computer-readable media may be any available media that may be accessed by the computing device 100. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 104 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 100. As used herein, computer storage media does not comprise signals per se.

The communication media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the communication media may include wired media such as a wired network or direct-wired connection, and wireless media such as acoustic, RF, infrared and other wireless media. Combinations of any of the above should also be included within the scope of computer-readable media.

The CPU(s) 106 may be configured to execute the computer-readable instructions to control one or more components of the computing device 100 to perform one or more of the methods and/or processes described herein. The CPU(s) 106 may each include one or more cores (e.g., one, two, four, eight, twenty-eight, seventy-two, etc.) that are capable of handling a multitude of software threads simultaneously. The CPU(s) 106 may include any type of processor, and may include different types of processors depending on the type of computing device 100 implemented (e.g., processors with fewer cores for mobile devices and processors with more cores for servers). For example, depending on the type of computing device 100, the processor may be an ARM processor implemented using Reduced Instruction Set Computing (RISC) or an x86 processor implemented using Complex Instruction Set Computing (CISC). The computing device 100 may include one or more CPUs 106 in addition to one or more microprocessors or supplementary co-processors, such as math co-processors.

The GPU(s) 108 may be used by the computing device 100 to render graphics (e.g., 3D graphics). The GPU(s) 108 may include hundreds or thousands of cores that are capable of handling hundreds or thousands of software threads simultaneously. The GPU(s) 108 may generate pixel data for output images in response to rendering commands (e.g., rendering commands from the CPU(s) 106 received via a host interface). The GPU(s) 108 may include graphics memory, such as display memory, for storing pixel data. The display memory may be included as part of the memory 104. The GPU(s) 108 may include two or more GPUs operating in parallel (e.g., via a link). When combined together, each GPU 108 may generate pixel data for different portions of an output image or for different output images (e.g., a first GPU for a first image and a second GPU for a second image). Each GPU may include its own memory, or may share memory with other GPUs.

In examples where the computing device 100 does not include the GPU(s) 108, the CPU(s) 106 may be used to render graphics.

The communication interface 110 may include one or more receivers, transmitters, and/or transceivers that enable the computing device to communicate with other computing devices via an electronic communication network, included wired and/or wireless communications. The communication interface 110 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet), low-power wide-area networks (e.g., LoRaWAN, SigFox, etc.), and/or the Internet.

The I/O ports 112 may enable the computing device 100 to be logically coupled to other devices including the I/O components 114, the presentation component(s) 118, and/or other components, some of which may be built in to (e.g., integrated in) the computing device 100. Illustrative I/O components 114 include a microphone, mouse, keyboard, joystick, game pad, game controller, satellite dish, scanner, printer, wireless device, etc. The I/O components 114 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 100. The computing device 100 may be include depth cameras, such as stereoscopic camera systems, infrared camera systems, RGB camera systems, touchscreen technology, and combinations of these, for gesture detection and recognition. Additionally, the computing device 100 may include accelerometers or gyroscopes (e.g., as part of an inertia measurement unit (IMU)) that enable detection of motion. In some examples, the output of the accelerometers or gyroscopes may be used by the computing device 100 to render immersive augmented reality or virtual reality.

The power supply 116 may include a hard-wired power supply, a battery power supply, or a combination thereof. The power supply 116 may provide power to the computing device 100 to enable the components of the computing device 100 to operate.

The presentation component(s) 118 may include a display (e.g., a monitor, a touch screen, a television screen, a heads-up-display (HUD), other display types, or a combination thereof), speakers, and/or other presentation components. The presentation component(s) 118 may receive data from other components (e.g., the GPU(s) 108, the CPU(s) 106, etc.), and output the data (e.g., as an image, video, sound, etc.).

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A computer-implemented method for representing three-dimensional (3D) scenes, comprising:
a) creating a plurality of first primitives;
b) predicting a plurality of second primitives from the plurality of first primitives; the plurality of second primitives comprising residual embeddings; and
c) rendering 3D scenes based on the first and second primitives.

2. The computer-implemented method of claim 1, wherein the plurality of first primitives comprising geometry attributes and reference embeddings.

3. The computer-implemented method of claim 2, wherein the plurality of second primitives comprising only the residual embeddings.

4. The computer-implemented method of claim 1, wherein Step b) further comprises obtaining geometry attributes of the plurality of second primitives by wrapping the plurality of first primitives via affine transform.

5. The computer-implemented method of claim 4, wherein affine parameters of the affine transform are adeptly predicted based on prediction features derived from the first and second primitives.

6. The computer-implemented method of claim 5, wherein the step of obtaining geometry attributes of the plurality of second primitives further comprises:
d) fusing the reference embeddings of one said first primitive and the residual embedding of a corresponding one of the second primitive by channel-wise concatenation to yield the prediction features;
e) deriving the affine parameters from the prediction features via learnable linear layers.

7. The computer-implemented method of claim 4, wherein the affine transform is performed to locations and covariances in geometry attributes of the plurality of first primitives to obtain locations and covariances of the plurality of second primitives.

8. The computer-implemented method of claim 5, wherein the affine parameters comprise a translation vector, a scaling matrix, and a rotation matrix, all of which predicted by neural networks.

9. The computer-implemented method of claim 5, wherein Step b) further comprises obtaining appearance attributes of the plurality of second primitives based on view embeddings and the prediction features.

10. The computer-implemented method of claim 9, wherein the view embeddings are generated from camera poses.

11. The computer-implemented method of claim 9, wherein the step of obtaining the appearance attributes further comprises:
f) concatenating the view embeddings and the prediction features in a channel-wise way to obtain concatenated features;
g) predicting color and opacity as the appearance attributes from the concatenated features using neural networks.

12. The computer-implemented method of claim 1, further comprising a step of optimizing the first and second primitives based on a rate-constrained optimization scheme.

13. The computer-implemented method of claim 12, wherein the step of optimizing the first and second primitives further comprises conducting entropy estimation to the first and second primitives to model bitrates of the first and second primitives.

14. The computer-implemented method of claim 13, wherein the step of conducting entropy estimation further comprises:
h) applying scalar quantization to reference embeddings and covariance in the plurality of first primitives, and to the residual embeddings of the plurality of second primitives;
i) estimating probability distributions of the reference embeddings, the covariance, and the residual embeddings.

15. The computer-implemented method of claim 14, wherein Step h) further comprises simulating rounding operators in the scalar quantization using quantization noises.

16. The computer-implemented method of claim 14, wherein in Step i), the probability distributions are modelled by Gaussian distribution.

17. The computer-implemented method of claim 12, wherein the rate-constrained optimization scheme utilizes a Lagrange multiplier for controlling a trade-off between rate and distortion.

18. The computer-implemented method of claim 1, wherein in Step c) the first and second primitives are used as 3D Gaussians; Step c) further comprising mapping the 3D Gaussians to target views to render the 3D scenes.

19. The computer-implemented method of claim 1, wherein the step of mapping the 3D Gaussians to target views to render the 3D scenes are conducted via volume splatting.

20. A non-transitory computer-readable memory recording medium having computer instructions recorded thereon, the computer instructions, when executed on one or more processors, causing the one or more processors to perform operations according to the method according to claim 1.

21. A computing system comprising:
one or more processors; and
memory containing instructions that, when executed by the one or more processors, cause the computing system to perform operations according to the method of claim 1.
